(19) United States
(12) Patent Application Publication
(10) Pub. No.: US 2005/0124773 A1
(43) Pub. Date: Jun. 9, 2005

(54) Extrudable fluoroelastomer composition

(76) Inventor: Phan Linh Tang, West Chester, PA (US)

Correspondence Address: DUPONT DOW ELASTOMERS, LLC;PATENT RECORDS CENTER, 4417 LANCASTER PIKE, BARLEY MILL PLAZA 25, WILMINGTON, DE, 19805, US

(21) Appl. No.: 10/957,358

(22) Filed: Oct. 1, 2004

Related U.S. Application Data
(60) Provisional application No. 60/528,248, filed on Dec. 9, 2003.

(51) Int. Cl. C08F 14/18

(52) U.S. Cl. 526/250; 526/255; 526/253

(57) ABSTRACT

Curable multimodal fluoroelastomer compositions contain a low viscosity fluoroelastomer component that imparts good extrusion performance and a high viscosity component that imparts good physical properties in cured articles. The fluoroelastomer comprises copolymerized units of vinylidene fluoride, hexafluoropropylene and tetrafluoroethylene. At least the low viscosity component also contains copolymerized units of a bromine- or iodine-containing cure site monomer such as 4-bromo-3,3, 4,4-tetrafluorobutene-1 or 4-iodo-3,3,4,4-tetrafluorobutene-1.

### CROSS-REFERENCE TO RELATED APPLICATIONS

This application claims the benefit of U.S. Provisional Application No. 60/528,248 filed Dec. 9, 2003.

### FIELD OF THE INVENTION

This invention pertains to curable fluoroelastomer compositions that contain a low viscosity fluoroelastomer component responsible for good extrusion performance and a high viscosity fluoroelastomer component responsible for good physical properties, wherein at least the low viscosity component contains copolymerized units of a cure site monomer selected from the group consisting of bromine-containing cure site monomers and iodine-containing cure site monomers.

### BACKGROUND OF THE INVENTION

Fluoroelastomers having excellent heat resistance, oil resistance, and chemical resistance have been used widely for sealing materials, containers and hoses. It can be difficult to manufacture a fluoroelastomer which processes well (i.e. extrudes or flows into molds readily) and which results in cured articles which have good physical properties such as tensile strength and compression set resistance. Generally, low molecular weight fluoroelastomers process well, but cured articles made therefrom may have poor physical properties. High molecular weight fluoroelastomers have good physical properties, but tend to be difficult to process.

Toda et al. (U.S. Pat. No. 5,218,026) discloses a multimodal peroxide curable fluoroelastomer composition having a portion of low molecular weight fluoroelastomer (for processability) and a portion of high molecular weight fluoroelastomer (for physical properties). The multimodal fluoroelastomer was made during the polymerization process by introducing an iodine-containing chain transfer agent after the desired amount of high molecular weight fluoroelastomer had been produced. Thus, the resulting elastomer had iodine cure sites located at chain ends, making it curable by organic peroxides.

Iodine-containing chain transfer agents can slow down fluoroelastomer polymerization reactions, making such polymerizations commercially unattractive. Additionally, a peroxide curable fluoroelastomer having iodine end group cure sites may be less thermally stable than a similar fluoroelastomer having copolymerized units of a bromine-containing cure site monomer rather than iodine end groups.

Thus, it would be desirable to have a fluoroelastomer composition having both good extrusion processability and good physical properties and which is economical to manufacture and has adequate thermal stability.

### SUMMARY OF THE INVENTION

One aspect of the present invention is a multimodal fluoroelastomer comprising copolymerized units of vinylidene fluoride, hexafluoropropylene and tetrafluoroethylene wherein said fluoroelastomer has a low viscosity portion having an inherent viscosity between 0.1 and 0.4 and a high viscosity portion having an inherent viscosity of at least 1, and wherein at least said low viscosity fluoroelastomer portion further comprises copolymerized units of a monomer selected from the group consisting of bromine-containing cure site monomers and iodine-containing cure site monomers.

Another aspect of the present invention is a curable composition comprising
A) a multimodal fluoroelastomer comprising copolymerized units of vinylidene fluoride, hexafluoropropylene and tetrafluoroethylene wherein said fluoroelastomer has a low viscosity portion having an inherent viscosity between 0.1 and 0.4 and a high viscosity portion having an inherent viscosity of at least 1, and wherein at least said low viscosity fluoroelastomer portion further comprises copolymerized units of a cure site monomer selected from the group consisting of bromine-containing cure site monomers and iodine-containing cure site monomers; and
B) a curative.

### DETAILED DESCRIPTION OF THE INVENTION

The present invention is directed to curable fluoroelastomer compositions which have good extrusion processability and, when cured, result in articles which have good physical properties. By the term “good extrusion processability” is meant that the compositions flow well into molds. By the term “good physical properties” is meant that the crosslinked fluoroelastomer compositions have at least comparable properties (e.g. tensile strength, modulus, elongation, compression set resistance) to that of conventional crosslinked monomodal high molecular weight fluoroelastomer compositions.

Fluoroelastomers employed in the present invention comprise copolymerized units of vinylidene fluoride (VF₂), hexafluoropropylene (HFP) and tetrafluoroethylene (TFE). Typically, the fluoroelastomers contain between 25-70 weight percent (wt. %) copolymerized units of VF₂, 19-60 wt. % units of HFP and 3-35 wt. % units of TFE.

The fluoroelastomers are multimodal, meaning that in a molecular weight distribution curve generated by gel permeation chromatography, the elastomer exhibits a plurality of peaks that are due to portions of fluoroelastomer having different average molecular weights. Fluoroelastomers employed in this invention contain at least one low molecular weight portion and at least one high molecular weight portion. The lowest molecular weight portion corresponds to an inherent viscosity (low viscosity portion) between 0.1 and 0.4, preferably between 0.15 and 0.25. The highest molecular weight portion corresponds to an inherent viscosity (high viscosity portion) of at least 1, preferably at least 1.3. Optionally, other intermediate molecular weight portions may be present in the fluoroelastomer.

At least the low viscosity fluoroelastomer further comprises a bromine-containing curesite monomer. Optionally, the high viscosity fluoroelastomer may also contain copolymerized units of a bromine-containing cure site monomer. Brominated cure site monomers may contain other halogens, preferably fluorine. Examples of brominated olefin cure site monomers are CF₂=CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R_{f}—O—CF═CF₂ (Rf is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr. Of the cure site monomers listed above, 4-bromo-3,3,4,4-tetrafluorobutene-1 (BTFB) is preferred. Units of cure site monomer are typically present at a level of 0.05-10 wt. % (based on the total weight of fluoroelastomer), preferably 0.05-5 wt. % and most preferably between 0.05 and 3 wt. %.

Although the cure site monomer is preferably a bromine-containing monomer, an iodine-containing monomer may optionally be employed in place of a bromine-containing cure site monomer. Iodine-containing curesite monomers typically have the same general formulas as the cure site monomers disclosed above, wherein iodine has been substituted for bromine.

Optionally, the fluoroelastomers employed in this invention may also contain iodine endgroups, on one or both polymer chain ends. The iodine end groups may be on either the high or low viscosity fluoroelastomer, or on both the high and low viscosity elastomers. Fluoroelastomers having iodine endgroups are well known in the art. They are typically made by introducing an iodine-containing chain transfer agent into the reactor during polymerization. If employed, the amount of chain transfer agent is calculated to result in an iodine level in the fluoroelastomer in the range of 0.005 to 2 wt. %, preferably 0.05 to 1 wt. %, most preferably 0.075 to 0.5 wt. %. The optional iodine-containing chain transfer agent is of the formula RI_{X} where R is a perfluoroalkyl or a chloroperfluoroalkyl group having 3 to 10 carbon atoms and x is 1 or 2. The chain transfer agent employed may actually be a mixture of compounds having the latter general formula. Specific examples include, but are not limited to 1,3-diiodoperfluoropropane; 1,4-diiodoperfluorobutane; 1,6-diiodoperfluorohexane; 1,8-diiodoperfluorooctane; 1,10-diiodoperfluorodecane; and monoiodoperfluorobutane. Methylene iodide may also be employed as an iodine-containing chain transfer agent.

Fluoroelastomers employed in this invention may be manufactured by suspension or emulsion polymerization processes. The emulsion polymerization process of this invention may be a continuous, semi-batch or batch process. The elastomer compositions may be made multimodal by a variety of means. One such means is the blending at least one high viscosity fluoroelastomer aqueous dispersion with at least one low viscosity fluoroelastomer aqueous dispersion, followed by coagulation and isolation of the resulting multimodal fluoroelastomer gum. Another means is by making a step change in reaction conditions at a desired point during the polymerization reaction. Such a change might include adjusting the reaction temperature or level of polymerization initiator. A preferred change in reaction conditions is to introduce a chain transfer agent to the reactor after a desired quantity of high viscosity polymer has been produced. Polymer produced thereafter will have a low viscosity. In a continuous polymerization process, the feed of chain transfer agent is typically cycled on and off several times during the reaction, whereas in a semi-batch process, feed of chain transfer agent is typically turned on only once, after a desired amount of high viscosity polymer has been made.

Suitable chain transfer agents include those disclosed in U.S. Pat. No. 3,707,529. Examples of such agents include isopropanol, diethylmalonate, ethyl acetate, carbon tetrachloride, acetone and dodecyl mercaptan.

Curable compositions of the present invention also contain a curative such as an organic peroxide or a polyhydroxy compound.

Useful organic peroxides are those which generate free radicals at curing temperatures. A dialkyl peroxide or a bis(dialkyl peroxide) which decomposes at a temperature above 50° C. is especially preferred. In many cases it is preferred to use a ditertiarybutyl peroxide having a tertiary carbon atom attached to a peroxy oxygen. Among the most useful peroxides of this type are 2,5-dimethyl-2,5-di(tertiarybutylperoxy)hexyne-3 and 2,5-dimethyl-2,5-di(tertiarybutylperoxy)-hexane. Other peroxides can be selected from such compounds as dicumyl peroxide, dibenzoyl peroxide, tertiarybutyl perbenzoate, and di[1,3-dimethyl-3-(t-butylperoxy)butyl]carbonate. Generally, about 1-3 parts by weight of peroxide per 100 parts by weight of fluoroelastomer (i.e. 1-3 phr) are used.

Curable compositions containing an organic peroxide curative also contain a polyfunctional unsaturated coagent which is capable of cooperating with the peroxide to provide a useful cure. These coagents can be added in an amount equal to 0.1 and 10 phr, preferably between 2-5 phr. Examples of suitable coagents include the following compounds: triallyl cyanurate; triallyl isocyanurate; tri(methallyl)isocyanurate; tris(diallylamine)-s-triazine; triallyl phosphite; N,N-diallyl acrylamide; hexaallyl phosphoramide; N,N,N′,N′-tetraalkyl tetraphthalamide; N,N,N′,N′-tetraallyl malonamide; trivinyl isocyanurate; 2,4,6-trivinyl methyltrisiloxane; and tri(5-norbornene-2-methylene)cyanurate. Particularly useful is triallyl isocyanurate (TAIC).

The curable compositions of this invention typically contain an acid acceptor. Such compounds include divalent metal oxides or hydroxides and organic compounds such as oxiranes or strong bases such as ProtonSponge® (available from Aldrich Chemical). Magnesium oxide and calcium hydroxide are preferred acid acceptors. The amount of acid acceptor employed in the compositions of this invention is generally between 1 and 30 phr, preferably between 1 and 10 phr.

Curable compositions of the invention that contain a polyhydroxy curative (or a derivative thereof) typically contain between 0.1 and 20 phr (preferably 1-3 phr) polyhydroxy compound. Polyhydroxy cross-linking agents include di-, tri-, and tetrahydroxybenzenes, naphthalenes, and anthracenes, and bisphenols of the formula 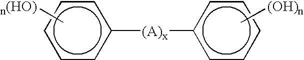
where A is a difunctional aliphatic, cycloaliphatic, or aromatic radical of 1-13 carbon atoms, or a thio, oxy, carbonyl, sulfinyl, or sulfonyl radical; A may optionally be substituted with at least one chlorine or fluorine atom; x is 0 or 1; n is 1 or 2; and any aromatic ring of the polyhydroxylic compound may optionally be substituted with at least one chlorine or fluorine atom, an amino group, a —CHO group, or a carboxyl or acyl radical. Preferred polyhydroxy compounds include hexafluoroisopropylidene-bis(4-hydroxy-benzene) (i.e. bisphenol AF or BPAF); 4,4′-isopropylidene diphenol (i.e. bisphenol A); 4,4′-dihydroxydiphenyl sulfone; and diaminobisphenol AF. Referring to the bisphenol formula shown above, when A is alkylene, it can be for example methylene, ethylene, chloroethylene, fluoroethylene, difluoroethylene, propylidene, isopropylidene, tributylidene, heptachlorobutylidene, heptafluorobutylidene, pentylidene, hexylidene, and 1,1-cyclohexylidene. When A is a cycloalkylene radical, it can be for example 1,4-cyclohexylene, 2-5 chloro-1,4-cyclohexylene, cyclopentylene, or 2-fluoro-1,4-cyclohexylene.

Further, A can be an arylene radical such as m-phenylene, p-phenylene, o-phenylene, methylphenylene, dimethylphenylene, 1,4-naphthylene, 3-fluoro-1,4-naphthylene, and 2,6-naphthylene. Polyhydroxyphenols of the formula 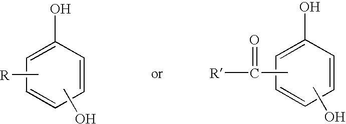
where R is H or an alkyl group having 1-4 carbon atoms or an aryl group containing 6-10 carbon atoms and R′ is an alkyl group containing 1-4 carbon atoms also act as effective crosslinking agents. Examples of such compounds include hydroquinone, catechol, resorcinol, 2-methylresorcinol, 5-methyl-resorcinol, 2-methylhydroquinone, 2,5-dimethylhydroquinone, 2-t-butyl-hydroquinone; and such compounds as 1,5-dihydroxynaphthalene and 2,6-dihydroxynaphthalene.

Additional polyhydroxy curing agents include alkali metal salts of bisphenol anions, quaternary ammonium salts of bisphenol anions, tertiary sulfonium salts of bisphenol anions and quaternary phosphonium salts of bisphenol anions. For example, the salts of bisphenol A and bisphenol AF. Specific examples include the disodium salt of bisphenol AF, the dipotassium salt of bisphenol AF, the monosodium monopotassium salt of bisphenol AF and the benzyltriphenylphosphonium salt of bisphenol AF.

Quaternary ammonium and phosphonium salts of bisphenol anions are discussed in U.S. Pat. Nos. 4,957,975 and 5,648,429. Bisphenol AF salts (1:1 molar ratio) with quaternary ammonium ions of the formula R₁R₂R₃R₄N⁺, wherein R₁-R₄ are C₁-C₈ alkyl groups and at least three of R₁-R₄ are C₃ or C₄ alkyl groups are preferred. Specific examples of these preferred compositions include the 1:1 molar ratio salts of tetrapropyl ammonium-, methyltributylammonium- and tetrabutylammonium bisphenol AF. Such salts may be made by a variety of methods. For instance a methanolic solution of bisphenol AF may be mixed with a methanolic solution of a quaternary ammonium salt, the pH is then raised with sodium methoxide, causing an inorganic sodium salt to precipitate. After filtration, the tetraalkylammonium/BPAF salt may be isolated from solution by evaporation of the methanol. Alternatively, a methanolic solution of tetraalkylammonium hydroxide may be employed in place of the solution of quaternary ammonium salt, thus eliminating the precipitation of an inorganic salt and the need for its removal prior to evaporation of the solution.

In addition, derivatized polyhydroxy compounds such as mono- or diesters, and trimethylsilyl ethers are useful crosslinking agents. Examples of such compositions include, but are not limited to resorcinol monobenzoate, the diacetate of bisphenol AF, the diacetate of sulfonyl diphenol, and the diacetate of hydroquinone.

When a polyhydroxy curative is employed in the curable compositions of this invention, a cure accelerator is also employed. Cure accelerators which may be used in the curable compositions of the invention include tertiary sulfonium salts such as [(C₆H₅)₂S⁺(C₆H₁₃)][Cl]⁻, and [(C₆H₁₃)₂S(C₆H₅)]⁺[CH₃CO₂]⁻ and quaternary ammonium, phosphonium, arsonium, and stibonium salts of the formula R₅R₆R₇R₈Y⁺ X⁻, where Y is phosphorous, nitrogen, arsenic, or antimony; R₅, R₆, R₇, and R₈ are individually C₁-C₂₀ alkyl, aryl, aralkyl, alkenyl, and the chlorine, fluorine, bromine, cyano, —OR, and —COOR substituted analogs thereof, with R being C₁-C₂₀ alkyl, aryl, aralkyl, alkenyl, and where X is halide, hydroxide, sulfate, sulfite, carbonate, pentachlorothiophenolate, tetrafluoroborate, hexafluorosilicate, hexafluorophosphate, dimethyl phosphate, and C₁-C₂₀ alkyl, aryl, aralkyl, and alkenyl carboxylates and dicarboxylates. Particularly preferred are benzyltri-phenylphosphonium chloride, benzyltriphenylphosphonium bromide, tetrabutylammonium hydrogen sulfate, tetrabutylammonium hydroxide, tetrapropylammonium hydroxide, tetrabutylammonium bromide, tributylallylphosphonium chloride, tributyl-2-methoxypropylphosphonium chloride, 1,8-diazabicyclo[5.4.0]undec-7-ene, and benzyldiphenyl(dimethylamino) phosphonium chloride. Other useful accelerators include methyltrioctylammonium chloride, methyltributylammonium chloride, tetrapropylammonium chloride, benzyltrioctylphosphonium bromide, benzyltrioctylphosphonium chloride, methyltrioctylphosphonium acetate, tetraoctylphosphonium bromide, methyltriphenylarsonium tetrafluoroborate, tetraphenylstibonium bromide, 4-chlorobenzyltriphenyl phosphonium chloride, 8-benzyl-1,8-diazabicyclo(5.4.0)-7-undecenonium chloride, diphenylmethyltriphenylphosphonium chloride, allyltriphenylphosphonium chloride, tetrabutylphosphonium bromide, m-trifluoromethylbenzyltrioctylphosphonium chloride, and other quaternary compounds disclosed in U.S. Pat. Nos. 5,591,804; 4,912,171; 4,882,390; 4,259,463; 4,250,278 and 3,876,654. The amount of accelerator used is between 0.1 and 20 phr. Preferably, 0.5-3.0 phr is used.

Optionally, curable compositions of the invention may be dual cured by the use of both a polyhydroxy curative and an organic peroxide curative in order to achieve a higher modulus and tensile strength in the resulting cured composition.

Other additives may be compounded into the fluoroelastomer composition to optimize various physical properties. Such additives include carbon black, fluoropolymer micropowders, stabilizers, plasticizers, lubricants, pigments, fillers, and processing aids typically utilized in fluoroelastomer compounding.

A conventional rubber mill or internal mixer may be used to combine the ingredients of the compositions of this invention.

The curable fluoroelastomer compositions of this invention are useful in many industrial applications including seals, wire coatings, tubing and laminates.

### EXAMPLES

### Test Methods

Mooney viscosity, ML (1+10), was determined according to ASTM D1646 with an L (large) type rotor at 121° C., using a preheating time of one minute and rotor operation time of 10 minutes.

Inherent viscosity was determined by dissolving 0.1 gram polymer in 1 deciliter methyl ethyl ketone, and measured at 30° C. using a capillary force flow viscometer (Viscotek, Houston).

Physical properties of the compositions described in the examples were measured according to the following test procedures.

| | |
|---|---|
| Oscillating Disc Rheometer (ODR) | ASTM D2084 |
| Tensile Strength (T_{B}) | ASTM D412 |
| Modulus (M₁₀₀) | ASTM D412 |
| Elongation at Break (E_{B}) | ASTM D412 |
| Hardness | ASTM D2240 |

The invention is further illustrated by, but is not limited to, the following examples.

### EXAMPLE 1

A multimodal fluoroelastomer of this invention was made by blending an aqueous dispersion of a high viscosity (HV) vinylidene fluoride (VF₂)/hexafluoropropylene (HFP)/tetrafluoroethylene (TFE) copolymer with an aqueous dispersion of low viscosity (LV) VF₂/HFP/TFE/4-bromo-3,3,4,4-tetrafluorobutene-1 (BTFB) copolymer and then isolating the resulting aqueous blend. These fluoroelastomer dispersions were made by a continuous emulsion polymerization process in a well-stirred 4.0-liter stainless steel liquid full reaction vessel at 115° C.

HV polymer dispersion: An aqueous solution, consisting of 3.12 g/hour (g/h) ammonium persulfate (initiator), 1.90 g/h sodium hydroxide, 6.58 g/h sodium octyl sulfonate surfactant (40 wt. % active ingredient), 1.35 g/h isopropanol (chain transfer agent) solution in deionized water, was fed to the reactor at a rate of 10 L/hour. The reactor was maintained at a liquid-full level at a pressure of 6.2 MPa by means of a back-pressure control valve in the effluent line. After 30 minutes, polymerization was initiated by introduction of a gaseous monomer mixture consisting of 605 g/h tetrafluoroethylene (TFE), 1016 g/h vinylidene fluoride (VF₂), and 1039 g/h hexafluoropropylene (HFP) fed through a diaphragm compressor. After 2.0 hours, collection of the resulting fluoroelastomer dispersion was begun and continued for 3.5 hours. The dispersion, which had a pH of 4.6 and contained 19.9 wt. % solids, was separated from residual monomers in a degassing vessel at atmospheric pressure.

LV polymer dispersion: An aqueous solution, consisting of 7.80 g/hour (g/h) ammonium persulfate (initiator), 4.75 g/h sodium hydroxide, 9.87 g/h sodium octyl sulfonate surfactant (40 wt. % active ingredient), and 37.50 g/h isopropanol solution in deionized water, was fed to the reactor at a rate of 10 L/hour. The reactor was maintained at a liquid-full level at a pressure of 6.2 MPa by means of a back-pressure control valve in the effluent line. After 30 minutes, polymerization was initiated by introduction of a gaseous monomer mixture consisting of 608 g/h tetrafluoroethylene (TFE), 1028 g/h vinylidene fluoride (VF₂), and 1117 g/h hexafluoropropylene (HFP) fed through a diaphragm compressor. After 15 minutes, BTFB (4-bromo-3,3,4,4-tetrafluorobutene-1 curesite monomer) was fed at 25.0 g/h. After 2.0 hours, collection of the resulting fluoroelastomer dispersion was begun and continued for 1.5 hours. The dispersion, which had a pH of 4.8 and contained 18.0 wt. % solids, was separated from residual monomers in a degassing vessel at atmospheric pressure.

All HV polymer dispersion and LV polymer dispersion was blended and fluoroelastomer crumb product was isolated using calcium nitrate solution. The coagulated fluoroelastomer polymer was allowed to settle, supernatant serum was removed, and the polymer was washed by reslurrying in water three times before filtering. The wet crumb was dried in an air oven at approximately 50⁰-65° C. to a moisture content of less than 1 wt. %. About 10 kg of fluoroelastomer was recovered. The product, containing 24.86 wt. % TFE units, 42.39 wt. % VF₂ units, 32.75 wt. % HFP units, and 0.34 wt. % BTFB units was an amorphous elastomer having a glass transition temperature of −13° C., as determined by differential scanning calorimetry (DSC) (heating mode, 10° C./minute, inflection point of transition). Inherent viscosity of the multimodal elastomer was 0.61 dL/g, measured at 30° C. in methyl ethyl ketone, and Mooney viscosity, ML (1+10), was 46.

### EXAMPLE 2

The inherent viscosities of the high viscosity (HV) and low viscosity (LV) portions of the fluoroelastomer composition made in Example 1 were determined by repeating the polymerizations under similar conditions, but isolating the HV and LV fluoroelastomers separately and measuring the inherent viscosities.

HV Polymer dispersion: An HV polymer dispersion was made in a well-stirred 4.0-liter stainless steel liquid full reaction vessel at 115° C. An aqueous solution, consisting of 3.12 g/hour (g/h) ammonium persulfate (initiator), 2.00 g/h sodium hydroxide and 6.58 g/h sodium octyl sulfonate surfactant (40 wt. % active ingredient) solution in deionized water, was fed to the reactor at a rate of 10 L/hour. The reactor was maintained at a liquid-full level at a pressure of 6.2 MPa by means of a back-pressure control valve in the effluent line. After 30 minutes, polymerization was initiated by introduction of a gaseous monomer mixture consisting of 605 g/h tetrafluoroethylene (TFE), 1141 g/h vinylidene fluoride (VF₂), and 914 g/h hexafluoropropylene (HFP) fed through a diaphragm compressor. After 2.0 hours, collection of the resulting fluoroelastomer dispersion was begun and continued for 6 hours. The dispersion, which had a pH of 4.6 and contained 21.33 wt. % solids, was separated from residual monomers in a degassing vessel at atmospheric pressure. The HV polymer dispersion was isolated using calcium nitrate solution. The coagulated fluoroelastomer polymer was allowed to settle, supernatant serum was removed, and the polymer was washed by reslurrying in water three times before filtering. The wet crumb was dried in an air oven at approximately 50°-65° C. to a moisture content of less than 1 wt. %. About 16 kg of fluoroelastomer was recovered. The HV polymer contained 28.6 wt. % TFE units, 40.77 wt. % VF₂ units, 30.63 wt. % HFP units. The Inherent viscosity was 1.74 dL/g, measured at 30° C. in methyl ethyl ketone.

LV polymer dispersion: A LV polymer dispersion was made in a well-stirred 4.0-liter stainless steel liquid full reaction vessel at 115° C. An aqueous solution, consisting of 7.80 g/hour (g/h) ammonium persulfate (initiator), 4.75 g/h sodium hydroxide, 9.87 g/h sodium octyl sulfonate surfactant (40 wt. % active ingredient), and 45.00 g/h isopropanol solution in deionized water, was fed to the reactor at a rate of 10 L/hour. The reactor was maintained at a liquid-full level at a pressure of 6.2 MPa by means of a back-pressure control valve in the effluent line. After 30 minutes, polymerization was initiated by introduction of a gaseous monomer mixture consisting of 596 g/h tetrafluoroethylene (TFE), 1153 g/h vinylidene fluoride (VF₂), and 992 g/h hexafluoropropylene (HFP) fed through a diaphragm compressor. After 15 minutes, BTFB (curesite monomer) was fed at 37.5 g/h. After 2.0 hours, collection of the resulting fluoroelastomer dispersion was begun and continued for 2.0 hours. The dispersion, which had a pH of 4.9 and contained 17.3 wt. % solids, was separated from residual monomers in a degassing vessel at atmospheric pressure. The LV polymer dispersion was isolated using calcium nitrate solution. The coagulated fluoroelastomer polymer was allowed to settle, supernatant serum was removed, and the polymer was washed by reslurrying in water three times before filtering. The wet crumb was dried in an air oven at approximately 50′-65° C. to a moisture content of less than 1 wt. %. About 4 kg of fluoroelastomer was recovered. The LV polymer had an inherent viscosity of 0.19 dL/g, measured at 30° C. in methyl ethyl ketone

### COMPARATIVE EXAMPLE A

A comparative VF₂/HFP/TFE multimodal fluoroelastomer (i.e. not having copolymerized units of a bromine-containing cure site monomer) was prepared by isolating a blended polymer aqueous dispersion of high viscosity (HV) polymer dispersion and low viscosity (LV) polymer dispersion. These polymer dispersions were made by a continuous emulsion polymerization process in a well-stirred 4.0-liter stainless steel liquid full reaction vessel at 115° C.

HV polymer dispersion: An aqueous solution, consisting of 3.12 g/hour (g/h) ammonium persulfate (initiator), 1.90 g/h sodium hydroxide, and 6.58 g/h sodium octyl sulfonate surfactant (40 wt. % active ingredient) solution in deionized water, was fed to the reactor at a rate of 10 L/hour. The reactor was maintained at a liquid-full level at a pressure of 6.2 MPa by means of a back-pressure control valve in the effluent line. After 30 minutes, polymerization was initiated by introduction of a gaseous monomer mixture consisting of 605 g/h tetrafluoroethylene (TFE), 1141 g/h vinylidene fluoride (VF₂), and 914 g/h hexafluoropropylene (HFP) fed through a diaphragm compressor. After 2.0 hours, collection of the resulting fluoroelastomer dispersion was begun and continued for 2.0 hours. The dispersion, which had a pH of 4.6 and contained 21.4 wt. % solids, was separated from residual monomers in a degassing vessel at atmospheric pressure.

LV polymer dispersion: An aqueous solution, consisting of 7.80 g/hour (g/h) ammonium persulfate (initiator), 4.50 g/h sodium hydroxide, 9.87 g/h sodium octyl sulfonate surfactant (40 wt. % active ingredient), and 30.0 g/h isopropanol solution in deionized water, was fed to the reactor at a rate of 10 L/hour. The reactor was maintained at a liquid-full level at a pressure of 6.2 MPa by means of a back-pressure control valve in the effluent line. After 30 minutes, polymerization was initiated by introduction of a gaseous monomer mixture consisting of 605 g/h tetrafluoroethylene (TFE), 1141 g/h vinylidene fluoride (VF₂), and 914 g/h hexafluoropropylene (HFP) fed through a diaphragm compressor. After 2.0 hours, collection of the resulting fluoroelastomer dispersion was begun and continued for 2.0 hours. The dispersion, which had a pH of 4.2 and contained 20.6 wt. % solids, was separated from residual monomers in a degassing vessel at atmospheric pressure.

All HV polymer dispersion and LV polymer dispersion was blended and fluoroelastomer crumb product was isolated using calcium nitrate solution. The coagulated fluoroelastomer polymer was allowed to settle, supernatant serum was removed, and the polymer was washed by reslurrying in water three times before filtering. The wet crumb was dried in an air oven at approximately 50°-65° C. to a moisture content of less than 1 wt. %. About 10 kg of fluoroelastomer was recovered. The product, containing 23.40 wt. % TFE units, 45.91 wt. % VF₂ units and 30.70 wt. % HFP units was an amorphous elastomer having a glass transition temperature of −16° C., as determined by differential scanning calorimetry (DSC) (heating mode, 10° C./minute, inflection point of transition). Mooney viscosity, ML (1+10), was 26.

### EXAMPLE 3

A multimodal VF₂/HFP/TFE/BTFB fluoroelastomer of the invention was prepared by isolating a multimodal polymer dispersion which had been made in the reactor by cycling polymerization conditions. The multimodal polymer dispersion was made by a continuous emulsion polymerization process in a well-stirred 2.0-liter stainless steel liquid full reaction vessel at 115° C. The process was cycled between conditions for making high viscosity (HV) fluoroelastomer for 80 minutes, and then switched to conditions to make low viscosity (LV) fluoroelastomer for 162 minutes and then back to conditions for HV fluoroelastomer, etc. for a total of 4 cycles. This was followed by 138 minutes of LV conditions and 82 minutes of HV conditions before the reaction was quenched.

HV Conditions: An aqueous solution, consisting of 1.69 g/hour (g/h) ammonium persulfate (initiator), and 1.04 g/h sodium hydroxide solution in deionized water, was fed to the reactor at a rate of 4.4 L/hour. The reactor was maintained at a liquid-full level at a pressure of 6.2 MPa by means of a back-pressure control valve in the effluent line. The polymerization was initiated and maintained by introduction of a gaseous monomer mixture consisting of 237 g/h tetrafluoroethylene (TFE), 401 g/h vinylidene fluoride (VF₂), and 446 g/h hexafluoropropylene (HFP) fed through a diaphragm compressor.

LV Conditions: An aqueous solution, consisting of 3.62 g/hour (g/h) ammonium persulfate (initiator), 2.22 g/h sodium hydroxide, 3.85 g/h sodium octyl sulfonate surfactant (40 wt. % active ingredient), and 11.71 g/h isopropanol solution in deionized water, was fed to the reactor at a rate of 4.4 L/hour. The reactor was maintained at a liquid-full level at a pressure of 6.2 MPa by means of a back-pressure control valve in the effluent line. The polymerization was maintained by introduction of a gaseous monomer mixture consisting of 237 g/h tetrafluoroethylene (TFE), 401 g/h vinylidene fluoride (VF₂), and 446 g/h hexafluoropropylene (HFP) fed through a diaphragm compressor. BTFB (curesite monomer) was fed at 9.8 g/h.

The resulting multimodal fluoroelastomer dispersion was isolated using calcium nitrate solution. The coagulated fluoroelastomer polymer was allowed to settle, supernatant serum was removed, and the polymer was washed by reslurrying in water three times before filtering. The wet crumb was dried in an air oven at approximately 50°-65° C. to a moisture content of less than 1 wt. %. About 18 kg of fluoroelastomer was recovered. The product, containing 24.28 wt. % TFE units, 41.32 wt. % VF₂ units, 34.41 wt. % HFP units, and 0.4 wt. % BTFB units (estimated) was an amorphous elastomer having a glass transition temperature of −11° C., as determined by differential scanning calorimetry (DSC) (heating mode, 10° C./minute, inflection point of transition). Inherent viscosity of the elastomer was 0.58 dL/g, measured at 30° C. in methyl ethyl ketone, and Mooney viscosity, ML (1+10), was 25.

Curable compositions of the invention were made by mixing the latter multimodal fluoroelastomer of the invention with curative and other ingredients on a conventional two-roll rubber mill, using standard mixing techniques employed in the elastomer industry. The formulations are shown in Table I.

Curing characteristics were measured by ODR (at 162° C., 3° arc, 100 range, 30 minutes) according to the Test Methods. The results are also shown in Table I.

Cured slabs were made by press molding at 162° C. for 30 minutes, followed by a post cure in an air oven at 232° C. for 16 hours. Tensile properties were measured according to the Test Methods and are shown in Table I.

TABLE I

| | Sample 1 | Sample 2 |
|---|---|---|
| Ingredient, phr¹ | | |
| Fluoroelastomer | 100 | 100 |
| VC50² | 2 | 2 |
| Elastomag 170³ | 3 | 3 |
| N990⁴ | 30 | 30 |
| Calcium hydroxide | 6 | 6 |
| Diak 7⁵ | 0 | 0.8 |
| Varox ™ DBPH-50⁶ | 0 | 0.8 |
| Curing Characteristics | | |
| M_{L}, dN · m | 10 | 10 |
| M_{H}, dN · m | 32 | 54 |
| Ts2, minutes | 14.9 | 7.1 |
| T′90, minutes | 22.6 | 18.5 |
| Tensile Properties | | |
| M₁₀₀, MPa | 2.4 | 3.9 |
| T_{B}, MPa | 9.8 | 11.8 |
| E_{B}, % | 317 | 240 |
| Hardness, Shore A | 63 | 69 |

¹phr is parts by weight per hundred parts rubber (i.e. fluoroelastomer).
²bisphenol AF and a salt of bisphenol AF with benzyltriphenylphosphonium chloride available from DuPont Dow Elastomers.
³Magnesium oxide available from Morton Performance Chemicals, Inc.
⁴MT Carbon black.
⁵Triallylisocyanurate available from DuPont Dow Elastomers.
⁶Organic peroxide available from R.T. Vanderbilt

### EXAMPLE 4

A multimodal VF₂/HFP/TFE/BTFB fluoroelastomer of the invention was prepared by isolating a multimodal polymer dispersion which had been made in the reactor by cycling polymerization conditions. The multimodal polymer dispersion was made by a continuous emulsion polymerization process in a well-stirred 2.0-liter stainless steel liquid full reaction vessel at 115° C. The process was cycled between conditions for making high viscosity (HV) fluoroelastomer for 80 minutes, and then switched to conditions to make low viscosity (LV) fluoroelastomer for 150 minutes and then back to conditions for HV fluoroelastomer, etc. for a total of 4 cycles. This was followed by 150 minutes of LV conditions and 70 minutes of HV conditions before the reaction was quenched.

HV Conditions: An aqueous solution, consisting of 1.69 g/hour (g/h) ammonium persulfate (initiator), and 1.04 g/h sodium hydroxide solution in deionized water, was fed to the reactor at a rate of 4.4 L/hour. The reactor was maintained at a liquid-full level at a pressure of 6.2 MPa by means of a back-pressure control valve in the effluent line. The polymerization was initiated and maintained by introduction of a gaseous monomer mixture consisting of 237 g/h tetrafluoroethylene (TFE), 401 g/h vinylidene fluoride (VF₂), and 446 g/h hexafluoropropylene (HFP) fed through a diaphragm compressor.

LV Conditions: An aqueous solution, consisting of 3.62 g/hour (g/h) ammonium persulfate (initiator), 2.22 g/h sodium hydroxide, 3.85 g/h sodium octyl sulfonate surfactant (40 wt. % active ingredient), and 11.71 g/h isopropanol solution in deionized water, was fed to the reactor at a rate of 4.4 L/hour. The reactor was maintained at a liquid-full level at a pressure of 6.2 MPa by means of a back-pressure control valve in the effluent line. The polymerization was maintained by introduction of a gaseous monomer mixture consisting of 237 g/h tetrafluoroethylene (TFE), 401 g/h vinylidene fluoride (VF₂), and 446 g/h hexafluoropropylene (HFP) fed through a diaphragm compressor. BTFB (curesite monomer) was fed at 9.8 g/h.

Inherent viscosity data were collected during the cycling polymerization. The Inherent viscosity cycled between as high as 1.7 dL/g and as low as 0.19 dL/g. The resulting multimodal fluoroelastomer dispersion was isolated using potassium aluminum sulfate solution. The coagulated fluoroelastomer polymer was allowed to settle, supernatant serum was removed, and the polymer was washed by reslurrying in water three times before filtering. The wet crumb was dried in an air oven at approximately 50°-65° C. to a moisture content of less than 1 wt. %. About 18 kg of fluoroelastomer was recovered. The product, containing 23.57 wt. % TFE units, 40.95 wt. % VF₂ units, 34.97 wt. % HFP units, and 0.5 wt. % BTFB units was an amorphous elastomer having a glass transition temperature of −11° C., as determined by differential scanning calorimetry (DSC) (heating mode, 10° C./minute, inflection point of transition). Inherent viscosity of the elastomer was 0.58 dL/g, measured at 30° C. in methyl ethyl ketone, and Mooney viscosity, ML (1+10), was 20.

1. A multimodal fluoroelastomer comprising copolymerized units of vinylidene fluoride, hexafluoropropylene and tetrafluoroethylene wherein said fluoroelastomer has a low viscosity portion having an inherent viscosity between 0.1 and 0.4 and a high viscosity portion having an inherent viscosity of at least 1, and wherein at least said low viscosity fluoroelastomer portion further comprises copolymerized units of a cure site monomer selected from the group consisting of bromine-containing cure site monomers and iodine-containing cure site monomers.

2. A multimodal fluoroelastomer of claim 1 wherein said cure site monomer is a bromine-containing cure site monomer.

3. A multimodal fluoroelastomer of claim 1 wherein said cure site monomer is a iodine-containing cure site monomer.

4. A multimodal fluoroelastomer of claim 1 wherein said low viscosity portion fluoroelastomer further comprises iodine endgroups.

5. A multimodal fluoroelastomer of claim 1 wherein said high viscosity portion fluoroelastomer further comprises copolymerized units of a cure site monomer selected from the group consisting of bromine-containing cure site monomers and iodine-containing cure site monomers.

6. A curable composition comprising:
A) a multimodal fluoroelastomer comprising copolymerized units of vinylidene fluoride, hexafluoropropylene and tetrafluoroethylene wherein said fluoroelastomer has a low viscosity portion having an inherent viscosity between 0.1 and 0.4 and a high viscosity portion having an inherent viscosity of at least 1, and wherein at least said low viscosity fluoroelastomer portion further comprises copolymerized units of a cure site monomer selected from the group consisting of bromine-containing cure site monomers and iodine-containing cure site monomers; and
B) a curing agent.

7. A curable composition of claim 6 wherein said fluoroelastomer cure site monomer is a bromine-containing cure site monomer.

8. A curable composition of claim 6 wherein said fluoroelastomer cure site monomer is a iodine-containing cure site monomer.

9. A curable composition of claim 6 wherein said low viscosity portion fluoroelastomer further comprises iodine endgroups.

10. A curable composition of claim 6 wherein said high viscosity portion fluoroelastomer further comprises copolymerized units of a cure site monomer selected from the group consisting of bromine-containing cure site monomers and iodine-containing cure site monomers.

11. A curable composition of claim 6 wherein said curative is an organic peroxide.

12. A curable composition of claim 6 wherein said curative is a polyhydroxy compound.

13. A curable composition of claim 6 wherein said curative is both an organic peroxide and a polyhydroxy compound.
